(19) United States
(12) Patent Application Publication
(10) Pub. No.: US 2012/0292831 A1
(43) Pub. Date: Nov. 22, 2012

(54) APPARATUS AND METHOD FOR THE PRODUCTION OF PLASTIC CONTAINERS FROM PREFORMS

(75) Inventors: Johannes Preiss, Regensburg (DE); Albert Link, Au in der Hallertau (DE); Klaus Karl Wasmuht, Ellingen (DE)

(73) Assignee: KRONES AG, Neutraubling (DE)

(21) Appl. No.: 13/471,533

(22) Filed: May 15, 2012

(30) Foreign Application Priority Data
May 17, 2011 (DE) 10 2011 075 958.1

(51) Int. Cl. B29C 49/00; B29C 49/28

(52) U.S. Cl. 264/572; 425/526

(57) ABSTRACT

An apparatus for the production of plastic containers from performs includes at least one oven configured to heat the performs. At least one blow molding station is configured to blow mold the plastic containers from the performs. A combined heat and power unit is configured to generate electric energy that at least drives the at least one blow molding station and to generate thermal energy that at least heats the at least one oven.

### CROSS-REFERENCE TO PRIOR APPLICATION

Priority is claimed to German Patent Application No. DE 10 2011 075 958.1, filed on May 17, 2011, the entire disclosure of which is hereby incorporated by reference herein.

### FIELD

The invention relates to an apparatus for the production of plastic containers from preforms, and to a corresponding method.

### BACKGROUND

It is well known that plastic containers for foodstuffs or pharmaceutical products can be produced in blow molding machines, specifically stretch blow molding machines. Preforms fabricated by injection molding are initially heated in an oven, before they receive their final shape by means of overpressure in an associated blow molding station. A disadvantage of this method is the high consumption of thermal and electric energy required for heating the preforms, for driving the blow molding machine and for generating the compressed air. Therefore, many attempts have already been made to optimize the use of energy in the production of plastic containers by means of the blow molding method or stretch blow molding method.

A heater for heating preforms is described, for example, in DE 10 2009 009867 A1, on which gas-operated heating elements are provided. The advantages associated therewith are the relatively high energetic efficiency as well as the relatively inexpensive energy source.

WO 2007/017429 A2 describes a reduction of the energy costs by recycling and converting pneumatic energy from compressed air, which inevitably has to be discharged from the respective blow molds after the containers have been blown.

JP-2001-0500454 A describes the recycling of steam and hot water in an injection molding machine, so as to use energy obtained by recycling for cooling and/or driving the machine.

### SUMMARY

In an embodiment, the present invention provides an apparatus for the production of plastic containers from performs. The apparatus includes at least one oven configured to heat the performs. At least one blow molding station is configured to blow mold the plastic containers from the performs. A combined heat and power unit is configured to generate electric energy that at least drives the at least one blow molding station and to generate thermal energy that at least heats the at least one oven.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 shows a schematic representation of an apparatus for the production of plastic containers with the associated flows of energy and media;

FIG. 2 shows a schematic representation of a heat radiator for exposing preforms to radiation; and

FIG. 3 shows a schematic representation of a modification of the heat radiator for exposing preforms to radiation.

### DETAILED DESCRIPTION

The present invention recognizes that it would be desirable to use the energy which is supplied during the production of plastic containers in blow molding machines more efficiently.

In an embodiment, the invention provides an apparatus which comprises, in addition to at least one oven for heating the preforms and at least one blow molding station for blow molding the plastic containers, a combined heat and power unit for generating electric energy at least for driving the blow molding station as well as for generating thermal energy at least for heating the oven. As the apparatus according to an embodiment of the invention requires both thermal energy and electric energy directly on site, a combined heat and power generation can be utilized particularly advantageously, especially because the demand for thermal energy and electric energy remains nearly constant during the normal operation of a blow molding machine, so that the available amounts of electric and thermal energy from the combined heat and power unit can be made use of continuously for the production. Moreover, the performance of the combined heat and power generation is, thus, well adaptable to the performance values of the plant components to be supplied.

It will be appreciated that the thermal energy demand and the electric energy demand for the apparatus according to an embodiment of the invention need not be covered by the mutual combined heat and power unit alone. Depending on the dimensions of the apparatus according to an embodiment of the invention, or the work load thereof, the thermal energy for heating the oven and/or the electric energy for driving the blow molding station may be supplied supplementally by another energy source, e.g. the public mains. For example, the apparatus according to an embodiment of the invention could be heat-operated, so that the combined heat and power unit provides for just about the thermal energy necessary for heating the preforms, while an amount of electric energy additionally required for the operation of the blow molding station is added externally from outside.

It would also be conceivable, however, that the combined heat and power unit is power-operated, so that the electric energy demand for the blow molding station and, if necessary, other plant components of the apparatus according to an embodiment of the invention is just about covered, while a thermal energy surplus is utilized elsewhere. Also, it would be possible, if necessary, that the oven is in this case additionally heated by an additional heater, especially if the amount of thermal energy supplied by the combined heat and power unit is not sufficient for heating the preforms. The operation of the blow molding station can include the energy supply of drives as well as the generation and/or providing of media such as compressed air.

Preferably, the oven comprises at least one heat radiator operated with thermal energy to heat up the preforms with heat radiation. This allows preheating the preforms with heat radiation in a contactless manner, which is particularly advantageous for the production. The operation with thermal energy implies the heat transfer by convection and heat conduction in a suitable fluid, so that waste heat from the combined heat and power unit can be transferred to the oven without a conversion of energy, e.g. to electric energy, and can be converted in this oven to heat radiation.

In a particularly advantageous embodiment the heat radiator comprises a radiator body, specifically from soapstone or fire brick, as well as a heat exchanger thermally coupled to the former, specifically at least one heat exchanger tube embedded in the radiator body, so as to transfer the thermal energy to the heat radiator. This provides for a particularly effective heat transfer and energy conversion, as well as a heat radiator allowing uniform radiation.

Preferably, the heat radiator comprises at least one heat exchanger tube for the generation of the heat radiation, which is pointing to the preforms to be heated up. Such a heat radiator is particularly easy to produce. Moreover, it allows an energy conversion and heat emission that can be locally dosed with particular precision.

Preferably, the combined heat and power unit is connected to the oven by a waste heat conduit, so as to transfer the thermal energy by means of a fluid, specifically by means of a combustion exhaust gas from the combined heat and power unit. This allows a physically flexible arrangement of the combined heat and power unit and the oven relative to each other. The fluid allows a particularly efficient heat transfer. The use of a combustion exhaust gas from the combined heat and power unit renders the use of an additional heat exchanger and heat exchanger medium unnecessary. It would also be possible, however, to provide a heat exchanger on the combined heat and power unit in order to cool combustion exhaust gases, and to conduct a heat exchanger medium heated by the heat exchanger through the waste heat conduit toward the oven.

Preferably, the length of the waste heat conduit is not more than 20 m, specifically not more than 10 m. This allows the heat energy emitted by the combined heat and power unit to be introduced into the oven without great losses. Moreover, this allows a flexible arrangement of the individual production units, e.g. the oven, the combined heat and power unit, fuel tanks and the like.

In a particularly advantageous embodiment the combined heat and power unit comprises a burner, which is suited to burn a fuel produced, at least proportionally, from biomass, specifically to burn biogas. This can reduce or even entirely avoid the use of fossil fuels, which serves not only the reduction of the CO₂ emission during the production of the plastic containers, but reduces costs in particular if the biomass can be obtained from the waste materials of an associated production. In terms of the emission behavior biogas is particularly environment-friendly and can be produced particularly easily from production waste, e.g. product rests or waste waters.

Preferably, the apparatus according to an embodiment of the invention further comprises a compressor for generating blow air and/or control air for the blow molding station, with the combined heat and power unit being adapted to be capable of supplying the compressor with electric energy. Thus, the energy expenditure for the generation of blow air and/or control air can be covered, at least proportionally, by the combined heat and power generation. Compressed air could also be supplied by a separate unit or from a compressed air reservoir, however.

Preferably, the apparatus according to an embodiment of the invention further comprises a cooler for cooling the blow molding station, with the combined heat and power unit being adapted to be capable of supplying the cooler with electric energy. Alternatively, the required cold can also be generated by an adsorption refrigeration system, using the exhaust air from the combined heat and power unit. Thus, the energy demand for cooling the blow molding station can be covered, at least proportionally, by the combined heat and power generation. A cooling agent could also be supplied by a separate unit, however.

In another embodiment, the method according to the invention comprises the steps of: a) heating the preforms; and b) blow molding the plastic containers. Moreover, electric energy for blow molding the plastic containers and thermal energy for heating the preforms are generated by a combined heat and power unit. In particular, the electric energy includes energy for the supply of drives, e.g. electric motors, and/or for providing the blow air. The generated thermal and/or electric energy may each be supplemented by an external supply of energy or from storage media.

Preferably, the thermal energy is transferred by means of a fluid, specifically by means of a combustion exhaust gas from the combined heat and power unit.

In a preferred embodiment at least a portion of the thermal energy is converted to heat radiation, and the preforms are heated by the heat radiation. This means that the heat radiation is converted directly from thermal energy, without the intermediate conversion to another form of energy, e.g. electric current.

Preferably, the combined heat and power unit is heated with a fuel, specifically biogas, obtained, at least proportionally, from biomass.

Preferably, the fuel is produced, at least proportionally, from product rests and/or waste water, specifically from product rests and/or waste water from the beverage production and/or bottling of beverages. In general, all organic wastes arising in the beverage production process are usable as fuels, in particular when subjected to processing in a biogas production plant. Thus, the apparatus according to an embodiment of the invention can be provided with an energy supply which may be an independent one.

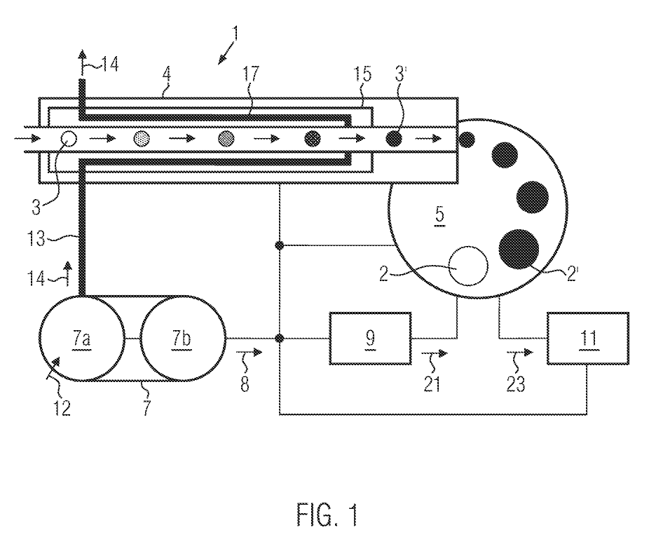

It can be seen in FIG. 1 that the apparatus 1 according to an embodiment of the invention for the production of plastic containers 2, e.g. PET bottles, from preforms 3 comprises an oven 4 for preheating the preforms 3, a blow molding station 5 for blow molding or stretch blow molding the containers 2 from the preheated preforms 3′, a combined heat and power unit 7 for generating electric energy 8 for the operation of the blow molding station 5, a compressor 9, and a cooler 11. The combined heat and power unit 7 preferably comprises a gas turbine 7a heated with biogas 12, or another suitable burner, as well as a generator 7b for the generation of current. Transfer devices for the preforms 3, 3′ and the containers 2 can be used.

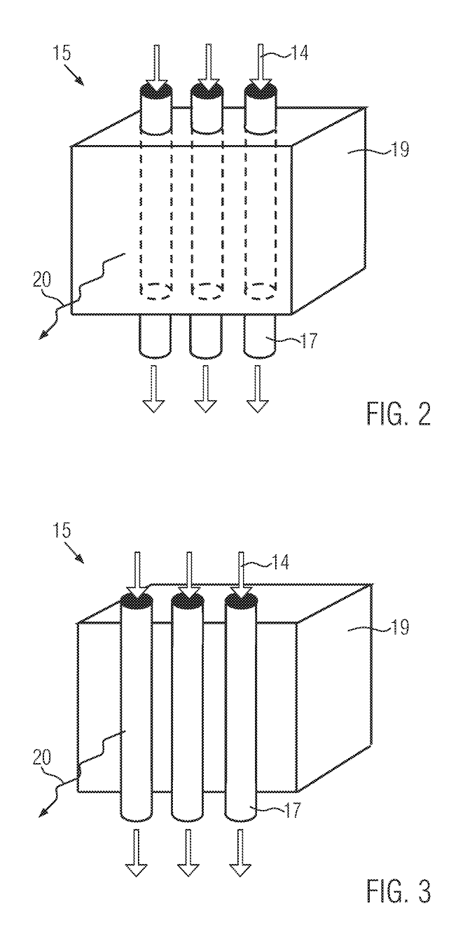

Moreover, the combined heat and power unit 7 is connected by a waste heat conduit 13 to the oven 4. A heat transfer medium 14, e.g. an exhaust gas from the combined heat and power unit 7, or another fluid suited for the transfer of heat, can be conducted in the waste heat conduit 13 through the oven 4, so as to heat at least one heat radiator 15 provided in the oven 4 by means of the heat transfer medium 14. The energy conversion to a suitable heat radiation is schematically explained in more detail in FIG. 2 and FIG. 3.

In the embodiment of the heat radiator 15 shown in FIG. 2 the heat radiator 15 comprises heat exchanger tubes 17 which are enclosed by a radiator body 19. The latter can be made, for example, from soapstone or refractory brick. Combinations of these materials or similar materials suited for heat radiation are possible as well, however. The heat exchanger tubes 17 are flown through by the heat transfer medium 14 and transfer thermal energy from the heat transfer medium 14 to the radiator body 19, which is thus heated to such an extent that it emits, in an areal manner, a heat radiation 20 which is suited to heat the preforms 3. For example, infrared light is suited as heat radiation 20. In order to allow an effective heat transfer between the heat exchanger tubes 17 and the radiator body 19 corresponding ducts are assigned to the heat exchanger tubes 17 in the radiator body 19.

In the modification of the heat radiator 15 as shown in FIG. 3 the heat exchanger tubes 17 are mounted on the surface of the radiator body 19, on the side of the radiator body 19 that is pointing to the preforms 3. In this case, the heat exchanger tubes 17 themselves act as heat radiator. The heat exchanger tubes 17 could, in this case, be arranged at predefined intervals in such a way that a rotating preform 3 moving past is exposed to radiation with different intensities, for example, selectively at circumferential segments of the preform 3. However, like the arrangement shown in FIG. 3, such an arrangement is merely exemplary.

With respect to the modifications of the heat radiator 15 as schematically outlined in FIGS. 2 and 3 it is significant that thermal energy from the heat transfer medium 14 is introduced into the heat radiator 15, where it can be converted to heat radiation 20. This allows the contactless heating of the preforms 3 by the heat radiation 20. In order to enhance an efficient heat transfer from the heat transfer medium 14 to the heat radiator 15 the heat exchanger tubes 17 in the heat radiators 15 could, of course, also comprise tube bends so as to provide for a heat transfer path that is optimized for the heat transfer.

Preferably, the heat transfer medium 14 is a combustion exhaust gas from the combined heat and power unit 7. The combined heat and power unit 7 is preferably based on a gas turbine 7a, which has the advantage that both biogas 12 and natural gas may be used as fuel. Thus, if necessary, at least a part of the energy demand for the combined heat and power unit can be covered by a non-fossil energy source.

A combined heat and power unit 7 heated in such a way is, in particular, advantageous if during the production of the plastic containers 2, such as PET bottles, or in an associated production plant for beverages organic waste arises, from which a suitable fuel can be obtained. It would then be conceivable to operate the combined heat and power unit 7 primarily with biogas 12, and cover merely a fuel amount portion to be supplemented with a fossil fuel.

The combined heat and power unit 7 is not limited to the use of biogas 12, however, but could combust also other environment-friendly organic waste materials and/or oils. It would also be possible to use another heat transfer medium 14 instead of exhaust gas. Conceivable is an exhaust gas heat exchanger, where applicable, with a closed heat transfer cycle through the waste heat conduit 13 for a suitable liquid and/or steam. It is significant that at least a portion of the energy required in the oven 4 for heating is transported from the combined heat and power unit 7 to the oven 4 in the form of thermal energy. Correspondingly, an energy conversion afflicted with losses, e.g. to electric energy 8, for the transport of energy becomes dispensable. This increases the energetic efficiency of the apparatus 1 according to an embodiment of the invention.

Depending on the construction of the apparatus 1 according to an embodiment of the invention a supplementary heater may be provided in the oven 4 so as to additionally heat the preforms 3 and/or the heat radiators 15 in case of need. Preferably, the combined heat and power unit 7 is constructed in such a way, however, that the oven 4 can be heated exclusively by the combined heat and power unit 7, at least during normal operation, i.e. after starting the plant. If the blow molding station 5, the compressor 9 and the refrigeration plant 11 are unable to receive all of the electric energy 8 produced by the combined heat and power unit 7, the residual amount of electric energy can be made available to other processes. Of course, it could also be used to operate a (non-illustrated) control unit, to control the apparatus 1 according to an embodiment of the invention or individual ones of the plant components described.

The combined heat and power generation according to an embodiment of the invention can be used in a blow molding machine particularly advantageously as substantially constant thermal and electric performance values are obtained as a result of the usually continuous work load of such a production unit. By this, the combined heat and power unit 7 can be efficiently adapted to the performance of the apparatus 1 according to an embodiment of the invention.

It would also be possible to integrate the apparatus 1 according to an embodiment of the invention, in particular the combined heat and power unit 7, in a higher-level energy management of a production plant, in particular of a beverage production plant. For example, the combined heat and power unit 7 could be configured to have an excess capacity in terms of the performance of the apparatus 1 according to an embodiment of the invention, so that a fuel amount obtained from the processing of biomass, which is available on a regular basis, is fully exploited. Excess thermal energy and/or electric energy could then be utilized by other consumers in the production plant. It would be particularly advantageous, however, if the apparatus 1 according to an embodiment of the invention were constructed as a production unit that is substantially autarchic with regard to the energy supply. Also, it would be possible to buffer possible excess capacities by suitable storage media and utilize them in the apparatus 1 according to an embodiment of the invention later.

The compressor 9 could produce both blow air 21 for blow molding the containers 2 and control air for controlling pneumatic valves and the like. The cooler 11 serves, for example, the fast cooling of the finished blow molded containers 2 and/or the blow molds provided on the blow molding station 5 by means of a cooling agent 23. For the reduction of energy losses it is an advantage to arrange the combined heat and power unit 7, the compressor 9 and the cooler 11 in the region of the blow molding station 5 and the oven 4. This allows relatively short conduction paths, in particular for the heat transfer medium 14 and the cooling agent 23. Preferably, the length of the waste heat conduit 13 is not more than 20 m. With a corresponding thermal insulation longer conduction paths and/or a physical separation of energy generators and energy consumers are possible as well, however. Short conduction paths would also be advantageous for a recycling of individual media, which may be combinable with the apparatus 1 according to an embodiment of the invention. It will be appreciated that the energy demand for the apparatus 1 according to an embodiment of the invention can be further optimized by combining the combined heat and power generation as described with the recycling of process media, e.g blow air 21.

The apparatus 1 according to an embodiment of the invention operates as follows:

Preferably, the combined heat and power unit 7 is heated with biogas 12, in particular from the utilization of production waste, so as to supply with the current generator 7b of the combined heat and power unit 7 at least a portion of the electric energy 8 required for the operation of the apparatus 1 according to an embodiment of the invention. The waste heat generated during the combustion in the combined heat and power unit 7 is conducted by the heat transfer medium 14, specifically in the form of an exhaust gas, in the waste heat conduit 13 and the heat exchanger tubes 17 through the oven 4, so as to heat the heat radiators 15 provided in the oven 4 with the waste heat. The residual heat still contained in the heat transfer medium 14′ downstream of the oven 4 may be utilized elsewhere, for example, in a shrink tunnel of a packaging unit, or may be stored.

A continuous flow of preforms 3 to be heated is moved along the heated heat radiators 15, and is preheated to a temperature suited for the subsequent blow molding of the containers in the blow molding station 5. The electric energy required for the operation of the oven is preferably generated by the generator 7b. Also, the electric energy demand for the blow molding station 5, the compressor 9 and the refrigeration plant 11 is covered as completely as possible by the combined heat and power unit 7. Alternatively, the required cold can also be generated by means of an adsorption refrigeration system, using the exhaust air from the combined heat and power unit. If necessary, an additionally required portion of the electric energy demand is covered by the mains or an energy storage device. Also, if necessary, a fossil fuel is combusted in the combined heat and power unit 7. Excess electric energy is fed into the mains or the associated production plant, or stored for later use.

The preheated preforms 3′ are transported into the blow molding station 5 so as to mold the containers 2 by stretching and blowing. By means of the cooler 11 the blow molded and initially hot containers 2′ are cooled, so that the finished blow molded and cooled containers 2 can be transported further to a downstream production unit.

The apparatus 1 as described and the corresponding method allow the use of resources, in particular primary energy, for the production of containers 2 such as PET bottles in a particularly efficient and environment-friendly manner.

While the invention has been described with reference to particular embodiments thereof, it will be understood by those having ordinary skill the art that various changes may be made therein without departing from the scope and spirit of the invention. Further, the present invention is not limited to the embodiments described herein; reference should be had to the appended claims.

What is claimed is:

1. An apparatus for the production of plastic containers from preforms, comprising:
at least one oven configured to heat the preforms; and
at least one blow molding station configured to blow mold the plastic containers from the preforms; and
a combined heat and power unit configured to generate electric energy that at least drives the at least one blow molding station and to generate thermal energy that at least heats the at least one oven.

2. The apparatus according to claim 1, wherein the at least one oven includes at least one heat radiator operated with the thermal energy and configured to heat up the preforms with heat radiation.

3. The apparatus according to claim 2, wherein the at least one heat radiator includes a radiator body and a heat exchanger thermally coupled to the radiator body so as to transfer the thermal energy to the at least one heat radiator.

4. The apparatus according to claim 3, wherein the radiator body includes at least one of soapstone and refractory brick and the heat exchanger includes at least one heat exchanger tube embedded in the at least one heat radiator.

5. The apparatus according to claim 2, wherein the at least one heat radiator includes at least one heat exchanger tube configured to generate the heat radiation in a direction toward the preforms to be heated up.

6. The apparatus according to claim 1, wherein the combined heat and power unit is connected to the at least one oven by a waste heat conduit so as to transfer the thermal energy via a fluid.

7. The apparatus according to claim 6, wherein the fluid is a combustion exhaust gas from the combined heat and power unit.

8. The apparatus according to claim 6, wherein the length of the waste heat conduit is not more than 20 m.

9. The apparatus according to claim 8, wherein the length of the waste heat conduit is not more than 10 m.

10. The apparatus according to claim 1, wherein the combined heat and power unit includes a burner configured to burn a fuel produced, at least proportionally, from biomass.

11. The apparatus according to claim 1, further comprising a compressor configured to generate, at the blow molding station, at least one of blow air and control air, the combined heat and power unit being configured to supply the compressor with the electric energy.

12. The apparatus according to claim 1, further comprising a cooler configured to cool the blow molding station, the combined heat and power unit being configured to supply the cooler with the electric energy.

13. The apparatus according to claim 1, further comprising an adsorption cooler configured to cool the blow molding station, the combined heat and power unit including a waste heat conduit and being configured to supply the adsorption cooler through the waste heat conduit.

14. A method for the production of plastic containers from preforms, the method comprising:
heating the preforms;
blow molding the plastic containers from the performs; and
generating, by a combined heat and power unit, thermal energy used in the heating and electric energy used in the blow molding.

15. The method according to claim 14, wherein the thermal energy is transferred by via a fluid, specifically by means of a combustion exhaust gas from the combined heat and power unit.

16. The method according to claim 15, wherein the fluid is a combustion exhaust gas from the combined heat and power unit.

17. The method according to claim 14, wherein at least a portion of the thermal energy is converted to heat radiation, and the preforms are heated by the heat radiation.

18. The method according claim 14, further comprising heating the combined heat and power unit with a fuel obtained, at least proportionally, from biomass.

19. The method according to claim 18, wherein the fuel is produced, at least proportionally, from waste water.

20. The method according to claim 18, wherein the fuel is produced, at least proportionally, from product rests.
